(19) United States
(12) Patent Application Publication
(10) Pub. No.: US 2019/0143963 A1
(43) Pub. Date: May 16, 2019

(54) METHOD FOR DETERMINING A SAFE SPEED AT A FUTURE WAY POINT

(71) Applicants: ZF Friedrichshafen AG, Friedrichshafen (DE); LUCAS AUTOMOTIVE GMBH, Koblenz (DE)

(72) Inventors: Matthias SCHLEGEL, Blaustein (DE); Jochen ABHAU, Bregenz (AT); Heinz-Joachim GILSDORF, Donnersdorf (DE); Julian KING, Rankweil (AT); Jochen KÖHLER, Dornbirn (AT); Horst KRIMMEL, Tettnang (DE); Gerhard NIEDERBRUCKER, Friedrichshafen (DE); Lara Ruth TURNER, Immenstaad (DE); Volker WAGNER, Ravensburg (DE); Robert ZDYCH, Friedrichshafen (DE); Vanessa ADLER, Niederwerth (DE); Sascha HEINRICHS-BARTSCHER, Neuwied (DE); Ralf RAFFAUF, Urmitz (DE); Holger SIMON, Elz (DE); Walter STEIN, Niederwerth (DE)

(73) Assignees: ZF Friedrichshafen AG, Friedrichshafen (DE); Lucas Automotive GmbH, Koblenz (DE)

(21) Appl. No.: 16/302,201

(22) PCT Filed: Apr. 27, 2017
(86) PCT No.: PCT/EP2017/060111

§ 371 Date: Nov. 16, 2018

(30) Foreign Application Priority Data
May 19, 2016 (DE) 10 2016 208 675.8

(51) Int. Cl. B60W 30/02; B60W 40/068; B60W 30/14; B60W 50/00; B60W 50/14

(52) U.S. Cl. CPC B60W 30/02; B60W 40/068; B60W 30/143; B60W 50/0097; B60W 50/14; B60W 2550/402; B60W 2550/148; B60W 2550/146; B60W 2520/10; B60W 2720/106; B60W 2400/00

(57) ABSTRACT

A method for determining a safe speed (v*) at a future waypoint (s*) of a vehicle moving along a route. In this step, at least one item of route data (in particular the curvature of the curve κ) characterizing the course of the route is determined. In addition, a first probability distribution (P_{ges}) of a coefficient of friction (μ) is provided at the current waypoint (s) and/or at the future waypoint (s*) of the vehicle. Subsequently a second probability distribution (Pᵥ) of a vehicle speed (v) at the future waypoint (s*) is determined from the at least one item of route data (κ) and from the first probability distribution (P_{ges}). The safe speed (v*) is determined by statistical analysis from the second probability distribution (Pᵥ).

This application is a National Stage application of PCT/EP2017/060111 filed Apr. 27, 2017, which claims priority from German patent application serial no. 10 2016 208 675.8 filed May 19, 2016.

### FIELD OF THE INVENTION

The invention relates to a method and a device for determining a safe speed at a future waypoint of a moving vehicle. Unless explicitly stated, the terms maximum coefficient of friction and coefficient of friction are used interchangeably below.

### BACKGROUND OF THE INVENTION

In principle, the assessment of the road conditions is up to the driver, who has to adapt his driving style to the former. Vehicle control systems such as ESC (Electronic Stability Control) or TCS (Traction Control System) or ABS (Antilock Braking System) help the driver to stabilize the vehicle in the limit range, supporting the driver in fulfilling the driving task in extreme situations. The effectiveness of such vehicle control systems essentially depends on the available maximum coefficient of friction μ (also referred to as maximum adhesion coefficient) at the current waypoint. There, the interaction between tire, surface and intermediate medium is crucial. Wet roads, snow and ice considerably reduce the available coefficient of friction between tires and road surface compared to the coefficient of friction available on a dry road surface. Suddenly changing coefficients of friction, such as those caused by changes in environmental conditions, can result in unstable driving situations and thus increase the risk of accidents. It is particularly dangerous if the driver of the vehicle approaches a curve too fast due to an incorrect assessment of the existing coefficient of friction.

Up to now, safe cornering speed is determined solely based on the map data of the routing of a road. Furthermore, a constant max. coefficient of friction (frequently p=1) is assumed. Ideally, the computation also includes a vehicle model that reflects the characteristics of the vehicle in question. In addition, for a known max. coefficient of friction, the vehicle can be decelerated at a distance from the curve to enable it to easily pass through.

### SUMMARY OF THE INVENTION

The invention addresses the problem of providing a method which can be used to determine a safe speed at a future waypoint of a vehicle moving along a route with a known course. Another problem the invention addresses is providing a suitable device.

These problems are solved by a method and a device according to the features of the independent claims. Advantageous embodiments will be apparent from the dependent claims.

A method is proposed for determining a safe speed at a future waypoint of a vehicle, which moves along a route with a known course, and comprises the following steps: providing at least one item of route data characterizing the course of the route; providing a first probability distribution of a max. coefficient of friction at the current waypoint and/or at the future waypoint of the vehicle; determining a second probability distribution of a vehicle speed at the future waypoint from the at least one item of route data and the first probability distribution; and determining the safe speed from the second probability distribution.

The method according to the invention is based on the consideration of taking into account not only the route ahead of the vehicle, but also possibly changing environmental conditions, which can considerably limit the maximum forces that can be transmitted at the tire. The starting point is a continuous or discrete probability distribution of the maximum coefficient of friction present at the current waypoint of the vehicle and/or at the future waypoint of the vehicle.

The method can detect whether the vehicle is moving too fast for the prevailing ambient conditions. In the case of too high a speed, a need for action can be deduced therefrom before reaching the future waypoint, and be output e.g. in the form of data, warning or an automated driving intervention (vehicle deceleration, etc.). In automated vehicles, e.g. using one or more vehicle assistance systems, the safe speed may be used to compute a driving strategy, for instance by limiting an optimization space within which a velocity trajectory is sought, which in no way exceeds the safe speed for the future waypoint.

The safe speed at the future waypoint can be determined by selecting a q-quantile of the second probability distribution. As known to a person skilled in the art, a quantile is a measure of central tendency in statistics. The q-quantile corresponds to the integral from the chosen safe speed to infinity of the second probability distribution. This means that the actual speed at which the vehicle can pass the future waypoint in a stable manner is greater than or equal to the safe speed with a probability of the selected q-quantile×100%. The safe speed at the future waypoint can be determined using the equation

∫ᵥ_{^{*}}∞P(v)dv=q_{S} (1)

In equation (1) v* is the safe velocity, P(v) the second probability distribution, and qₛ the selected q-quantile. The q-quantile qₛ is given and the safe velocity v* is determined using equation (1).

Alternatively, the p-quantile of the second probability distribution may be used to determine a safe speed, i.e., the integral from 0 to the safe speed v*. The equation below applies to the selected p-quantile pₛ

∫₀^{v}^{^{*}}(v)dv=p_{S}=1−q_{S} (1.1)

A curvature of the curve at and/or before the future waypoint of the vehicle can be processed as the at least one item of route data. If the curvature of the curve is known, the second probability distribution can be determined from the equation

αₓ²+κ²(s)*vₓ⁴−g²*μ²(s)=0 (2)

In the formula, aₓ is the longitudinal acceleration of the vehicle, K is the curvature of the curve, s is the path, g is the gravitational constant, vₓ is the speed of the vehicle in the direction of its longitudinal axis (vehicle longitudinal speed), p is the coefficient of friction. The given equation (2) is based on the assumption that the vehicle can be regarded as a simplified mass point. Of course, more complex vehicle models can be used to determine the second probability distribution.

According to a further embodiment, the step of determining the second probability distribution is conducted based on the assumption that the vehicle passes unaccelerated along the route, in particular through the future waypoint. As a result, the term αₓ² can be ignored in equation (2) and a simple conversion of the probability distribution of the coefficient of friction μ at the relevant waypoint s to the probability distribution of the vehicle speed vₓ can be conducted.

In particular, a value is selected as the q-quantile, which depends on the vehicle type, the chassis type or the selected driving mode. The q-quantile characterizes a safe speed processing system. The safe speed can be selected differently, depending on the type of vehicle, for instance a sports car, a comfortable sedan, an off-road vehicle, etc. If a vehicle has a vehicle assistance system, which can be used to set different suspension modes, then for instance, an individual q-quantile that takes the driving characteristics of the vehicle into account can also be defined for different modes.

The q-quantile is preferably chosen such that the resulting selected safe speed is less than the true safe speed at the future selected waypoint. In that way it can be ensured that no dangerous situation for the vehicle results at the future waypoint.

According to a further expedient embodiment, a device for determining a safe speed at a future waypoint of a vehicle that moves along a route with a known course is proposed. The device comprises a first means for determining a second probability distribution of a vehicle speed at the future waypoint from at least one item of route data characterizing the course of the route and from a first probability distribution of a max. coefficient of friction at the current waypoint and/or at the future waypoint of the vehicle; and a second means for determining the safe speed from the second probability distribution. The first probability distribution can be determined by a computing unit of the vehicle and provided for further processing to determine the safe speed.

The device according to the invention has the same advantages as described above in conjunction with the method according to the invention.

The device may comprise further means for executing the method described.

### BRIEF DESCRIPTION OF THE DRAWINGS

Below, the invention is described in more detail with reference to an exemplary embodiment in the drawings. In the drawings:

FIG. 1 shows a schematic representation of a program flowchart of the method according to the invention, and

FIG. 2 shows a schematic representation of the procedure for determining a safe speed at a future waypoint of a vehicle.

### DETAILED DESCRIPTION OF THE PREFERRED EMBODIMENTS

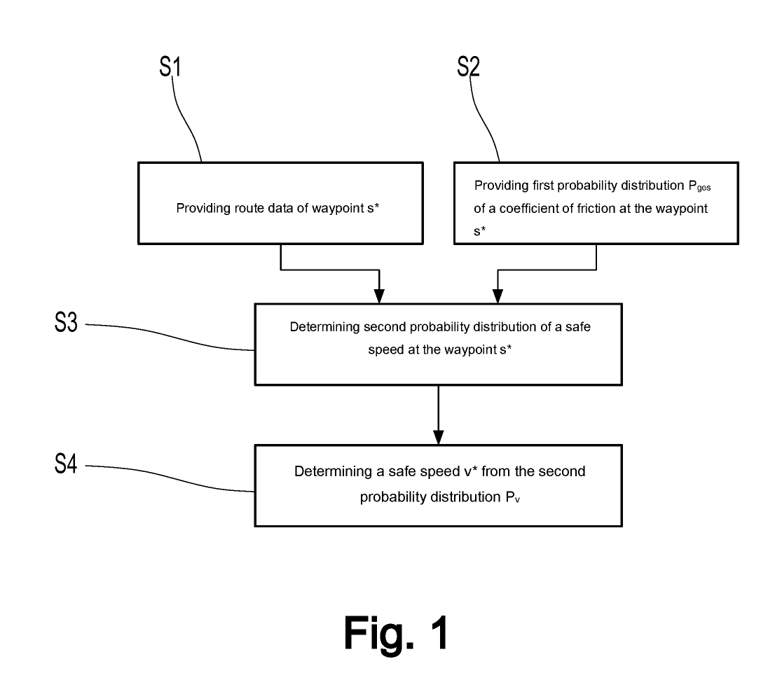

FIG. 1 shows the schematic sequence of the method according to the invention for determining a safe speed v* of a vehicle at a future waypoint s* in a flow chart. The future waypoint s* is, for instance, a curve towards which the vehicle traveling along a (known) course moves in the longitudinal direction of the vehicle. In particular, the vertex of this curve can be considered to be the future waypoint s*. Alternatively, the future waypoint s* may be at a constant distance ahead of the vehicle (projection horizon). A computing unit of the vehicle can determine the data about the route ahead of the vehicle and the next curve ahead of the vehicle from the map data of a navigation system. In a step S1, one or more item(s) of route data characterizing the course of the route is/are provided. Such route data characterizing the course of the route includes, in particular, a curvature of the curve κ at the future waypoint s*. In addition, the curvature of the curve before and/or beyond the future waypoint s* of the vehicle can be processed as route data.

In a second step S2, a first probability distribution P_{ges} of a max. coefficient of friction μ at the current waypoint s and/or at the future waypoint s* of the vehicle is provided. The probability distribution P_{ges} (μ) may be provided in discrete or continuous form. The manner in which such a probability distribution is determined is not the subject matter of this method.

In general, the max. coefficient of friction can be determined by direct or indirect methods. The determination of the max. coefficient of friction by direct methods is called effect-based and can be subdivided into direct, active and direct, passive methods. In a direct, active method, an active intervention in the driving dynamics of the vehicle is effected by braking and/or steering. In a direct, passive method, there is no active intervention in the driving dynamics of the vehicle. Instead, there is only an observation of effects of the coefficient of friction on the tire tread, the vehicle and such in the course of driving maneuvers of the vehicle, which the latter performs to achieve a predetermined navigation destination. To measure the effects of the coefficient of friction and to infer a max. coefficient of friction therefrom with sufficient certainty, the transmission of high forces at the tire is a prerequisite.

For indirect, cause-based methods, the max. coefficient of friction is determined based on parameters that affect it physically. These may be, for instance, a tread pattern, the rubber compound of a tire, its temperature, an inflation pressure, the road surface, its temperature, its condition (e.g., snowy or wet), etc.

The estimation of a coefficient of friction at a future waypoint of a vehicle may be described by way of example using a method comprising the following steps: a first set of parameters, which were or are determined for a current waypoint of the vehicle and which characterize the max. coefficient of friction at the current waypoint of the vehicle, are used to perform a prediction of a first probability distribution for the max. coefficient of friction at the current waypoint of the vehicle using a Bayesian network. Further, a second probability distribution for the max. coefficient of friction at the future waypoint of the vehicle is estimated from a second set of data about the future waypoint. Finally, a resulting, combined probability distribution is determined from the first and the second probability distribution. To be able to estimate the distribution of the coefficient of friction at the future waypoint in front of the vehicle, according to this exemplary procedure, the variables affecting the max. coefficient of friction both under the vehicle (i.e., at the current waypoint) and in front of the vehicle are processed. By making use of a large number of available data under and in front of the vehicle, the prediction quality of the coefficient of friction distribution at the future waypoint is high.

In principle, other procedures for providing a probability distribution of the max. coefficient of friction at the current waypoint and/or at the future waypoint of the vehicle can be processed within the framework of this method.

By means of an analytical relationship and the route data(s), in particular the curvature of the curve κ, the present probability distribution P_{ges}(μ) at the future waypoint s* can be converted into a probability distribution Pᵥ(v), where v represents the vehicle speed of the vehicle. This determination is made as step S3 in the diagram shown in FIG. 1.

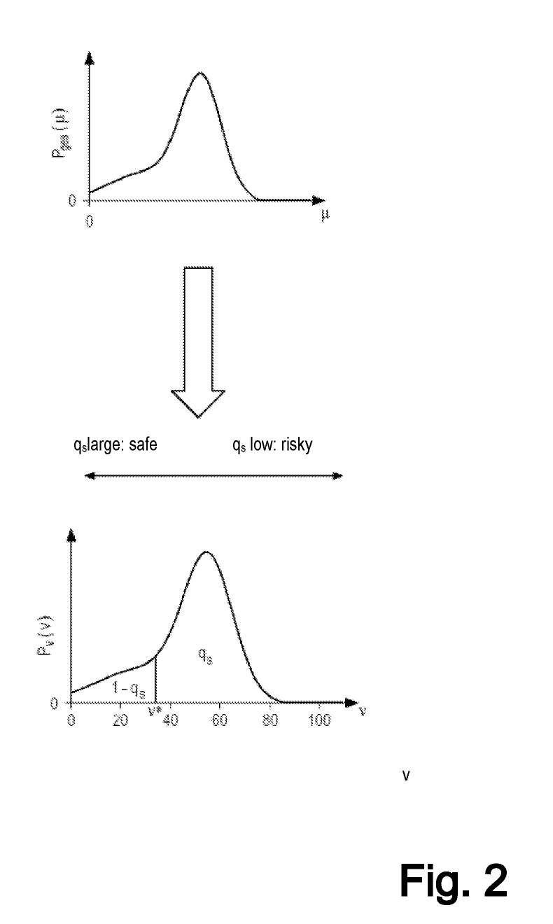

As a further step S4, the safe speed v* is determined from the now determined probability distribution of the velocity Pᵥ(v) at the waypoint s*. This procedure will be described with reference to FIG. 2.

The upper half of FIG. 2 shows in a continuous probability distribution P_{ges}(μ) as a function of the max. coefficient of friction μ. The diagram shows e.g. the probability distribution P_{ges}(μ) at the current waypoint and/or at the future waypoint s* of the vehicle. The probability distribution P_{ges}(μ) can, for instance, be the result of the combination of multiple probability distributions at respective waypoints between the current waypoint and the future waypoint s*. This is assumed to be given.

The conversion of the probability distribution P_{ges}(μ) into the probability distribution Pᵥ(v) of the velocity at the future waypoint s* is conducted, for instance, on the basis of the differential equation according to equation (2). In this formula, vₓ represents the speed of the vehicle in the direction of its longitudinal axis (vehicle longitudinal speed), aₓ the acceleration of the vehicle in the direction of its longitudinal axis (vehicle longitudinal acceleration), κ the curvature of the curve, s the path, g the gravitational constant and μ the coefficient of friction. In processing equation (2), the vehicle shall be considered as a mass point for the sake of convenience. Another vehicle model can also be used, however. The curvature of the curve κ results from the above-mentioned map data for the relevant waypoint, in this case the chosen future waypoint s*. For the sake of simplicity, it is assumed that the vehicle passes through the considered waypoint s* unaccelerated which is why the term αₓ is omitted from equation (2). This can be used to determine the probability value of the speed for the different coefficients of friction according to the probability distribution shown in FIG. 2 above. By way of example, the probability distribution Pᵥ(v) shown in FIG. 2 below results as a function of the vehicle speed v.

The determination of the safe speed v* at the future waypoint s* (also referred to as the look-ahead point) is made by selecting a q-quantile qₛ of the determined probability distribution Pᵥ(v) as a function of the speed v. In FIG. 2, the q-quantile is denoted by qₛ, wherein qₛ represents a safety parameter.

According to equation (1), qₛ corresponds to the integral of the probability distribution Pᵥ over the interval of the safe speed v* to infinity. This means that the actual speed at which the future waypoint s* can be passed in a stable manner is greater than or equal to the selected speed v* with a probability of qₛ×100%. The larger the selected qₛ, the safer the speed selection.

To determine the safe speed, a specific value for qₛ is specified for a vehicle type (for instance sports car, sedan or off-road vehicle) and/or depending on a chassis (sports suspension, comfort chassis or chassis selection selectable by mode selection). The q-quantile qₛ is selected permanently for a vehicle type and/or a chassis type/driving mode of the vehicle. The safe speed v* can then be calculated from the given q-quantile qₛ and equation (1). It is obvious that the selected safe speed v* does not correspond to the true safe speed, which is actually unknown. However, the safe speed v* is chosen by an appropriate selection of the q-quantile, which is likely to be lower than the true safe speed.

An action strategy can be derived from the now available safe speed v* for the future waypoint s*. If it is determined that the actual speed of the vehicle at the waypoint s* is greater than the determined safe speed v* or only slightly below the safe speed v*, then a need for action can be derived therefrom. Such a need for action may include data or a warning of the driver or, in the case of an existing driver assistance system, an automated vehicle deceleration. In autonomous vehicles, the safe speed v* can be used to limit an optimization space within which a suitable velocity trajectory is determined.

The present method is based on the consideration of predetermining a criticality of the driving situation at this waypoint for existing friction data about a future waypoint on the basis of the computed safe speed at this waypoint and on a speed prognosis based on the utilization of the current coefficient of friction of the driver taking into account route data. This can be used to derive the mentioned action recommendation, as, e.g., a preconditioning of a suspension system, a deceleration of the vehicle or a warning to the driver.

### REFERENCE NUMERALS

s current waypoint
s* future waypoint
k curvature of the curve
P_{ges}(μ) first probability distribution
Pᵥ(v) second probability distribution
μ coefficient of friction
qₛ q-quantile
vₓ longitudinal vehicle speed
aₓ longitudinal vehicle acceleration

1-10. (canceled)

11. A method for determining a safe speed (v*) at a future waypoint (s*) of a vehicle moving along a route, the method comprising:
providing at least one item of route data characterizing a course of the route (in particular curvature κ);
providing a first probability distribution (P_{ges}) of a maximum coefficient of friction (μ) at at least one of a current waypoint (s) and the future waypoint (s*) of the vehicle;
determining a second probability distribution (Pᵥ) of a vehicle speed (v) at the future waypoint (s*) from the at least one item of route data (κ) and the first probability distribution (P_{ges});
determining the safe speed (v*) from the second probability distribution (Pᵥ).

12. The method of claim 11, further comprising determining the safe speed (v*) at the future waypoint (s*) by selecting a q-quantile of the second probability distribution (Pᵥ).

13. The method of claim 11, further comprising determining the safe speed (v*) at the future waypoint (s*) by selecting a p-quantile of the second probability distribution (Pᵥ).

14. The method of claim 11, further comprising processing a curvature of a curve (κ), as the at least one item of route data, at least one of at the future waypoint and before the future waypoint (s*) of the vehicle.

15. The method according to claim 11, further comprising determining the second probability distribution (Pᵥ) according to a formula of:
αₓ²+kappa²(s)*vₓ⁴−g²*μ²(s)=0

16. The method according to claim 11, further comprising determining the second probability distribution (Pᵥ) based on an assumption that the vehicle is a mass point having a given mass of the vehicle.

17. The method according to claim 11, further comprising determining the second probability distribution (Pᵥ) based on an assumption that the vehicle passes along the route at the future waypoint (s*) in an unaccelerated manner.

18. The method according to claim 12, further comprising selecting a fixed value for the vehicle as the q-quantile, which depends on one of a vehicle type, a chassis type and a driving mode.

19. The method according to claim 12, further comprising choosing the q-quantile such that the resulting determined safe speed (v*) is lower than a true safe speed at the future waypoint (s*).

20. The method according to claim 13, further comprising selecting a fixed value for the vehicle as the p-quantile which depends on one of a vehicle type, a chassis type and a driving mode.

21. The method according to claim 13, further comprising choosing the p-quantile such that the resulting determined safe speed (v*) is lower than a true safe speed at the future waypoint (s*).

22. The method according to claim 13, further comprising determining the safe speed (v*) from the second probability distribution by statistical analysis.

23. A device for determining a safe speed at a future waypoint (s*) of a vehicle moving along a route, the device comprising:
a first means for determining a second probability distribution (Pᵥ) of a vehicle speed (v) at the future waypoint (s*) from at least one item of route data (κ) characterizing a course of the route and from a first probability distribution (P_{ges}) of a maximum coefficient of friction (μ) at at least one of a current waypoint (s) of the vehicle and the future waypoint (s*); and
a second means for determining the safe speed (v*) from the second probability distribution (Pᵥ).

24. A method for determining a safe speed (v*) at a future waypoint (s*) of a vehicle moving along a route, comprising:
providing to a computing unit of the vehicle, from map data of a navigation system, route data about the route ahead of the vehicle and a bend in the route ahead of the vehicle at the future waypoint;
providing, from the map data of the navigation system to the computing unit, a curvature of the bend in the route ahead of the vehicle at the future waypoint as an item of the route data that characterizes a course of the route;
providing, via the computing unit, a first probability distribution (P_{ges}) of a maximum coefficient of friction (μ) at at least one of a current waypoint (s) of the vehicle and the future waypoint (s*) of the vehicle;
determining, via the computing unit, a second probability distribution (Pᵥ) of a vehicle speed (v) at the future waypoint (s*) from the curvature of the bend in the route at the future waypoint and from the first probability distribution (P_{ges});
determining by statistical analysis, via the computing unit, the safe speed (v*) at the future waypoint from the second probability distribution;
comparing, via the computer, an actual speed of the vehicle at the future waypoint to the determined safe speed at the future waypoint; and
if the actual speed of the vehicle, at the future waypoint, is greater than the determined safe speed at the future waypoint, either issuing a warning to a driver of the vehicle that the actual speed is greater than the determined safe speed, or decelerating the vehicle via an existing driver assistance system.
